(19) United States
(12) Patent Application Publication
(10) Pub. No.: US 2025/0011131 A1
(43) Pub. Date: Jan. 9, 2025

(54) METHOD FOR IDENTIFYING A SITUATION OF BEING STUCK IN AN ELEVATOR SYSTEM, CONTROL DEVICE FOR AN ELEVATOR SYSTEM, ELEVATOR SYSTEM, COMPUTER PROGRAM, AND COMPUTER-READABLE MEDIUM

(71) Applicant: Inventio AG, Hergiswil (CH)

(72) Inventors: Thomas Eilinger, Kussnacht am Rigi (CH); Raphael Ulrich, Gisikon (CH)

(21) Appl. No.: 18/704,963

(22) PCT Filed: Nov. 3, 2022
(86) PCT No.: PCT/EP2022/080607

§ 371 Date: Apr. 26, 2024

(30) Foreign Application Priority Data
Nov. 3, 2021 (EP) 21206114.7

(51) Int. Cl. B66B 5/02; B66B 1/34

(52) U.S. Cl. CPC B66B 5/02; B66B 1/3476

(57) ABSTRACT

A method identifies a stuck situation of an elevator car and a counterweight suspended by carrying means on a traction sheave rotated by an electric motor. The method includes: receiving a load signal of a weight of a load located in the car; determining a preliminary torque depending on the load signal; receiving a speed signal representative of an actual speed of the car); monitoring a correction torque over a specified monitoring time period, the correction torque being determined depending on the speed signal and a specified reference speed such that the actual speed of the car approximates the reference speed; identifying the stuck situation wherein the car or the counterweight remains stuck, when the monitored correction torque meets at least one specified criterion; and carrying out a specified safety measure when the stuck situation is identified.

### FIELD

The present invention relates to a method for identifying a situation of being stuck in an elevator system. Furthermore, the invention relates to a control device for the elevator system, to a computer program, and to a computer-readable medium for carrying out such a method. The invention also relates to an elevator system equipped with such a control device.

### BACKGROUND

FIG. 1 shows a typical elevator system 20, such as a passenger or freight elevator. Such an elevator system 20 generally comprises an elevator shaft 22, a car 24, a counterweight 26, an electric motor 30, which motor has a traction sheave 32, carrying means 28, and a brake 34, which can be located on the axle of the electric motor 34 or on the car. The carrying means 28 can, for example, have one or more cables, straps or belts. For the sake of simplicity, the carrying means 28 will hereinafter be used in the singular. However, it should be noted that the presence of two or more carrying means 28 is not thereby ruled out. The car 24 is arranged in the elevator shaft 22 so as to be vertically displaceable. The counterweight 26 is connected to the car 24 by the carrying means 28. The traction sheave 32 can be rotated by means of the electric motor 30. The carrying means 28 runs over the traction sheave 32 and optionally over a deflection roller 33 and can be moved by means of the traction sheave 32 so that the car 24 and the counterweight 26 can be displaced vertically by operating the electric motor 30 in cooperation with the carrying means 28. The brake 34 enables braking and/or stopping of the car 24. Alternatively or additionally, a further brake can be arranged for braking and/or stopping the counterweight 26. A control device 40 is communicatively coupled to the electric motor 30 and/or the brake 34 for controlling the electric motor 30 and/or the brake 34, respectively.

A load 46 can be introduced into or removed from the car 24 via a first access point 36 in a first floor. The load 46 can be introduced into or removed from the car 24 via a second access point 38 in a second floor above the first floor. The load 46 can be placed in the car 24 on a floor 44 of the car 24, wherein a weight sensor 42 for identifying a weight of the load 46 can be arranged on the floor 44. The load 46 can be transported from the first floor to the second floor or from the second floor to the first floor by means of the car 24. Furthermore, further floors and corresponding access points (not shown) can be present, which can be approached by means of the car 24.

During the vertical displacement of the car 24, due to the coupling between the car 24 and the counterweight 26 by means of the carrying means 28, the counterweight 26 is also displaced vertically, namely in the opposite direction to the car 24. It can happen that either the car 24 or the counterweight 26 remains stuck. In general, four different situations of being stuck can occur. A first situation of being stuck relates to the car 24 being dynamically stuck. In this case, the car 24 initially moves and then remains stuck. A second situation of being stuck relates to the car 24 being statistically stuck. The car 24 remains stuck before it can be set in motion. A third situation of being stuck relates to the counterweight 26 being dynamically stuck. In this case, the counterweight 26 initially moves and then remains stuck. A fourth situation of being stuck relates to the counterweight 26 being statistically stuck. In this case, the counterweight 26 remains stuck before it can be set in motion.

If, for example, the car 24 remains stuck, it can be the case that the counterweight 26 is initially raised further due to the friction between the carrying means 28 and the traction sheave 32. As soon as this friction is no longer sufficient to further raise the counterweight 26, the counterweight 26 falls until the carrying means 28 is tensioned again. In this case, large forces can be transmitted to the carrying means 28 and, via the carrying means 28, to the car 24, which can damage them and/or loads in the car 24 and cause them to become defective, for example can harm or injure persons.

If, for example, the counterweight 26 remains stuck, it can be the case that the car 24 is initially raised further due to the friction between the carrying means 28 and the traction sheave 32. As soon as this friction is no longer sufficient to further raise the car 24, the car 24 falls until the carrying means 28 is tensioned again. In this case, large forces can be transmitted to the carrying means 28 and, via the carrying means 28, to the counterweight 26 and damage it. In addition, due to the falling of the car 24, loads, for example persons, in the car 24 can be harmed or injured.

It is known to prevent only the counterweight 26 or the car 24 from being raised in this way by the traction sheave 32 and/or the carrying means 28 being designed such that, in the event of the car 24 or the counterweight 26 being stuck, it slides over the traction sheave 32 and does not raise the counterweight 26 or the car 24 any further. It is also known, alternatively or additionally, to arrange an electronic safety device, also referred to as KSS or KSS1, which is designed to identify when the tension of the carrying means 28 on the side with car 24 or the counterweight 26 decreases such that the carrying means 28 is slack on the corresponding side. Due to the large risk that can arise if the situations of being stuck are not identified or are not identified in time, it would, however, be desirable to provide an additional securing function and/or to integrate the securing function into the control device 40 of the elevator system 20, namely independently of the aforementioned electronic safety device KSS/KSS1.

Methods for identifying a situation of being stuck are known from US2020283259A1 and US2015114761A1.

### SUMMARY

There may therefore be a need for an alternative or additional method for identifying a situation of being stuck in an elevator system. In particular, there may be a need for a method by which the situation of being stuck is identified reliably and quickly and/or that can be implemented in a control device of the elevator system. Furthermore, there may be a need for the control device, for a computer program product and a computer-readable medium for performing such a method as well as for an elevator system equipped with such a control device.

Such a need can be met by the subject matter of any of the advantageous embodiments defined in the following description.

A first aspect of the invention relates to a method for identifying a situation of being stuck in an elevator system. The elevator system has an elevator shaft, a car which is arranged in the elevator shaft, a counterweight which is coupled to the car by way of a carrying means, an electric motor which has a traction sheave which can be rotated by means of the electric motor, over which the carrying means runs and by means of which the carrying means can be moved so that the car and the counterweight can be displaced vertically by operating the electric motor, and a brake, by means of which the car and/or the counterweight can be braked and/or stopped. The method comprises: receiving a load signal which is representative of a weight of a load which is located in the car and which is intended to be transported by means of the car; determining a preliminary torque depending on the load signal; receiving a speed signal which is representative of an actual speed of the car; monitoring a correction torque over a specified monitoring time period, wherein the correction torque is determined depending on the speed signal and a specified reference speed such that the actual speed of the car approximates the reference speed; identifying the situation of being stuck, whereby the car or the counterweight remains stuck in the elevator shaft, when the monitored correction torque meets at least one specified criterion; and carrying out a specified safety measure when the situation of being stuck is identified.

The method can, for example, be automatically carried out by a processor of the control device of the elevator system.

In summary, the method described here and below, in particular monitoring the correction torque and identifying the situation of being stuck when the monitored correction torque meets the specified criterion, enables a reliable and/or rapid identification of all possible situations of being stuck and can be implemented easily and/or with little effort into a control device for controlling the electric motor of the elevator system.

It is particularly advantageous that, in order to carry out the method from a technical point of view, no separate electronic safety device is necessary in order to identify the situation of being stuck. However, the method can optionally be implemented in a separate electronic safety device, which can be arranged in addition to and/or independently of the control device of the elevator system.

Possible features and advantages of embodiments of the invention can be regarded, inter alia and without limiting the invention, as being based upon the concepts and findings described below.

The load signal can be generated by means of a sensor, for example by means of the weight sensor 42 in the floor 44 of the car 24, and can be received by the control device, for example the control device 40. Alternatively, the load signal can be determined in that a difference between a weight that is suspended on a side of the traction sheave on which the counterweight is suspended and a weight that is suspended on a side of the traction sheave on which the car is suspended are determined. Since the weight of the car, the weight of the counterweight, the position of the car, and a specific weight of the carrying means are known, this difference is representative of the weight of the load and can be encoded in the load signal.

The speed signal can be generated by a rotational speed sensor, for example an encoder, which, for example, comprises a magnet and a magnetic sensor and which detects a rotational speed of the electric motor or of the traction sheave, and can be received by the control device. The reference speed can be determined and/or specified by the control device, wherein, for the sake of simplified explanation, it is assumed below that the reference speed is specified by the control device.

The aforementioned situation of being stuck can be subdivided into different cases of being stuck, wherein a distinction is made in the different cases of being stuck as to whether a load is located in the car.

FIG. 2 shows eight different cases of being stuck, which each fall under one of the aforementioned situations of being stuck. In particular, FIG. 2 shows four different cases 1 to 4 of being stuck in which the car 24 is empty and the four different cases 5 to 8 of being stuck in which the car 24 is loaded with the load 46. Furthermore, in the cases of being stuck, a distinction is made regarding in which direction the traction sheave 32 is rotating; the arrows drawn over the traction sheaves 32 indicate a direction of rotation of the traction sheave 32 (counterclockwise in cases 1, 2, 5 and 6 of being stuck; clockwise in cases 3, 4, 7, and 8 of being stuck). Furthermore, a distinction is made in the cases of being stuck regarding whether the car 24 (in cases 1, 3, 5 and 7 of being stuck) or the counterweight 26 (in cases 2, 4, 6, and 8 of being stuck) remains stuck.

In case 1 of being stuck, the car 24 is intended to be moved downward, but remains stuck. If the traction sheave 32 is rotated further, the counterweight 26 can be raised further, the carrying means 28 can lose tension on the side with the car 24 and, at a later point in time, the counterweight 26 can fall downward into the carrying means 28 in an uncontrolled manner. In this case, before getting stuck, a first motor axle torque TM, which is applied by the electric motor 30 in order to lower the car 24, is equal to a negative second torque TME, the negative system torque. After getting stuck, the first torque TM is much smaller than the negative second torque TME, since now the electric motor 30 has to further raise the counterweight 26 without the assistance of the weight of the car 24. The application torque is the maximum torque required by the system at constant travel. This is present with a full car or alternatively an empty car. The worst case with respect to the car position, cable weight, and friction in the system is taken into account.

In case 2 of being stuck, the car 24 is intended to be moved downward, but the counterweight 26 remains stuck. The carrying means 28 cannot be moved further, which is why the car 24 cannot be moved further downward. In this case, before getting stuck, the first torque TM is equal to the negative second torque TME. After getting stuck, the first torque TM is much smaller than the negative second torque TME, since the electric motor 30 attempts to raise the blocked counterweight 26.

In case 3 of being stuck, the car 24 is intended to be moved upward, but remains stuck. The carrying means 28 cannot be moved further, which is why the counterweight 26 cannot be moved further downward. In this case, before getting stuck, the first torque TM is equal to the negative second torque TME. After getting stuck, the first torque TM is much greater than the positive second torque TME, since the electric motor 30 attempts to raise the blocked car 24.

In case 4 of being stuck, the car 24 is intended to be moved upward, but the counterweight 26 remains stuck. If the traction sheave 32 is rotated further, the car 24 can be raised further, the carrying means 28 can lose tension on the side with the counterweight 26 and, at a later point in time, the car 24 can fall downward into the carrying means 28 in an uncontrolled manner. In this case, before getting stuck, the first torque TM is equal to the negative second torque TME. After getting stuck, the first torque TM is much greater than the positive second torque TME, since now the electric motor 30 has to further raise the car 24 without the assistance of the counterweight 26.

In case 5 of being stuck, the car 24 is intended to be moved downward together with the load 46, but remains stuck. If the traction sheave 32 is rotated further, the counterweight 26 can be raised further, the carrying means 28 can lose tension on the side with the car 24 and, at a later point in time, the counterweight 26 can fall downward into the carrying means 28 in an uncontrolled manner. In this case, before getting stuck, the first torque TM is equal to the positive second torque TME. After getting stuck, the first torque TM is much smaller than the negative second torque TME, since now the electric motor 30 has to further raise the counterweight 26 without the assistance of the weight of the car 24 and the load 46.

In case 6 of being stuck, the car 24 is intended to be moved downward together with the load 46, but the counterweight 26 remains stuck. The carrying means 28 cannot be moved further, which is why the car 24 cannot be moved further downward. In this case, before getting stuck, the first torque TM is equal to the positive second torque TME. After getting stuck, the first torque TM is much smaller than the negative second torque TME, since the electric motor 30 attempts to raise the blocked counterweight 26.

In case 7 of being stuck, the car 24 is intended to be moved upward together with the load 46, but remains stuck. The carrying means 28 cannot be moved further, which is why the counterweight 26 cannot be moved further downward either. In this case, before getting stuck, the first torque TM is equal to the positive second torque TME. After getting stuck, the first torque TM is much greater than the positive second torque TME, since the electric motor 30 attempts to raise the blocked car 24 and the load 46.

In case 8 of being stuck, the car 24 is intended to be moved upward together with the load 46, but the counterweight 26 remains stuck. If the traction sheave 32 is rotated further, the car 24 can be raised further, the carrying means 28 can lose tension on the side with the counterweight 26 and, at a later point in time, the car 24 can fall downward into the carrying means 28 in an uncontrolled manner. In this case, before getting stuck, the first torque TM is equal to the positive second torque TME. After getting stuck, the first torque TM is much greater than the positive second torque TME, since now the electric motor 30 has to further raise the car 24 and the load 46 without the assistance of the counterweight 26.

It can thus be seen from FIG. 2 that, in all cases of being stuck and thus also in all situations of being stuck, the amount of torque that the electric motor has to apply in order to reach the desired acceleration and/or speed is rapidly and strongly, in other words suddenly, increased. This can be identified reliably and quickly, for example, by monitoring the correction torque. All the situations of being stuck can thus be identified reliably and quickly by means of the aforementioned method.

A second aspect of the invention relates to a control device having a processor, which is configured to carry out the method according to one embodiment of the first aspect of the invention. The control device can be part of the elevator system or part of an independent safety device for the elevator system, in addition to the normal elevator control system. The control device may comprise hardware and/or software modules. In addition to the processor, the control device may comprise a memory and data communication interfaces for data communication with peripheral devices. Features of the method according to one embodiment of the first aspect of the invention may also be features of the control device, and vice versa.

A third aspect of the invention relates to an elevator system, for example a freight or passenger elevator. The elevator system comprises an elevator shaft, a car which is arranged in the elevator shaft, a counterweight which is arranged in the elevator shaft and is coupled to the car by way of a carrying means, an electric motor which has a traction sheave which can be rotated by means of the electric motor, over which the carrying means runs and by means of which the carrying means can be moved so that the car and the counterweight can be displaced vertically by means of operating the electric motor, a brake by means of which the car and/or the counterweight can be braked and/or stopped, and a control device according to one embodiment of the second aspect of the invention.

A fourth aspect of the invention relates to a computer program, which comprises commands that prompt a processor to carry out the method according to one embodiment of the first aspect of the invention when the computer program is executed by the processor.

A fifth aspect of the invention relates to a computer-readable medium on which the computer program according to one embodiment of the fourth aspect of the invention is stored. The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the method according to an embodiment of the first aspect of the invention can also be features of the computer program and/or of the computer-readable medium, and vice versa.

According to one embodiment, when monitoring the correction torque, a maximum correction torque and a minimum correction torque are determined within a specified time period, wherein the specified criterion is met if a difference between the maximum correction torque and the minimum correction torque is greater than a specified threshold. The determination of the difference and the comparison of the difference with the specified threshold enable the situation of being stuck to be identified in a simple manner. In particular, by means of this monitoring, all the possible situations of being stuck and cases of being stuck mentioned above can be reliably identified, as explained in more detail below. The time period during which the minimum and maximum correction torque and the corresponding difference are determined can be referred to, for example, as a monitoring period or as a time window. Since the monitoring process can run continuously, the time window can float. In this context, the time window can also be referred to as a floating window or monitoring window.

According to one embodiment, a total torque is determined depending on the preliminary torque and the correction torque, and at least one reference current for operating the electric motor is determined depending on the total torque. The determination of the reference current depending on the preliminary torque and the correction torque can contribute in a simple manner to the car being moved at the desired speed and/or comfortably, i.e., without jolting or with only slight jolting. The total torque can be, for example, the sum of the preliminary torque and correction torque.

According to one embodiment, the preliminary torque comprises a load torque and an acceleration torque. The determination of the preliminary torque depending on the load torque and the acceleration torque can contribute to the car being moved steadily and/or without jolting, in particular when travel starts. The preliminary torque can be, for example, the sum of the load torque and acceleration torque.

According to one embodiment, the load torque is determined in such a way that the car does not move due to the determined load torque alone when the brake is released. If exclusively the load torque were thus applied by the electric motor, the car would not move when the brake is released. This can contribute to the car being moved steadily and/or without jolting, in particular when travel starts.

According to one embodiment, the load signal is representative of a difference between a weight suspended on a side of the traction sheave on which the counterweight is suspended and a weight suspended on a side of the traction sheave on which the car is suspended. The load torque is determined depending on the load signal. The load torque can also be determined depending on a traction sheave diameter of the traction sheave, a gear ratio, and a reeving factor (also referred to as a cable suspension factor). Since the weight of the car, the weight of the counterweight, the position of the car, and a specific weight of the carrying means are known, this difference is representative of the weight of the load and can be encoded in the load signal.

According to one embodiment, the acceleration torque is determined such that the car moves with a reference acceleration due to the acceleration torque. It can thereby be assumed that the acceleration torque is not required to keep the car at its speed, since the load torque is sufficient for this purpose. The acceleration torque thus relates exclusively to the proportion of the total torque, in particular of the preliminary torque, which is required in order to keep the car in constant accelerated travel. The reference acceleration can be determined and/or specified by the control device.

According to one embodiment, a current mass moment of inertia, which is representative of the current mass inertia of the elevator system, is determined. The acceleration torque is determined depending on the current mass moment of inertia and a reference acceleration. The acceleration torque can also be determined depending on the traction sheave diameter, the gear ratio, and the reeving factor. The current mass moment of inertia depends on the degree of loading of the car. The degree of loading can be generated by means of a sensor, for example by means of a weight sensor in the floor of the car, and can be received by the control device.

According to one embodiment, the specified safety measure comprises stopping the electric motor and/or generating an error message. Stopping the electric motor contributes in a simple manner to the counterweight not being raised further when the car remains stuck, or the car being raised further when the counterweight remains stuck. The generation of the error message makes it possible to log one or more situations of being stuck and, if necessary, to be able to attribute them to a system error.

According to one embodiment, monitoring the correction torque is started when at least one specified starting condition is met. This can contribute to preventing safety measures with respect to the situation of being stuck from being triggered in situations in which no situation of being stuck can occur or in which the occurrence of the situation of being stuck is not critical.

According to one embodiment, the starting condition comprises the correction torque being determined at least twice in a row and the correction torque meeting the specified criterion both times it is determined. In other words, monitoring can be started without delay, but the situation of being stuck is only identified if the specified criterion is met the second time. Expressed in an alternative but technically equivalent way, monitoring can only be started after the specified criterion has been met for the first time. Alternatively or additionally, the starting conditions can comprise the fact that the reference speed is not equal to zero. Alternatively or additionally, the starting conditions can comprise the fact that a specified run-up period has elapsed after the car has started traveling. These starting conditions can contribute individually or in any combination to preventing jolting of the car at the beginning of a journey, which can cause a sudden change in the correction torque, from being incorrectly interpreted as a situation of being stuck.

Embodiments of the invention will be described below with reference to the accompanying drawings, wherein neither the drawings nor the description are intended to be interpreted as limiting the invention.

### DESCRIPTION OF THE DRAWINGS

FIG. 1 shows an elevator system according to one embodiment of the invention.

FIG. 2 shows a table in which different cases of being stuck are illustrated.

FIG. 3 shows a control device according to one embodiment of the invention.

FIG. 4 shows an exemplary profile of a torque difference between a maximum correction torque and a minimum correction torque.

FIG. 5 shows a flow chart for a method according to one embodiment of the invention.

The drawings are merely schematic, and not to scale. In the different figures, identical reference signs denote identical or similar features.

### DETAILED DESCRIPTION

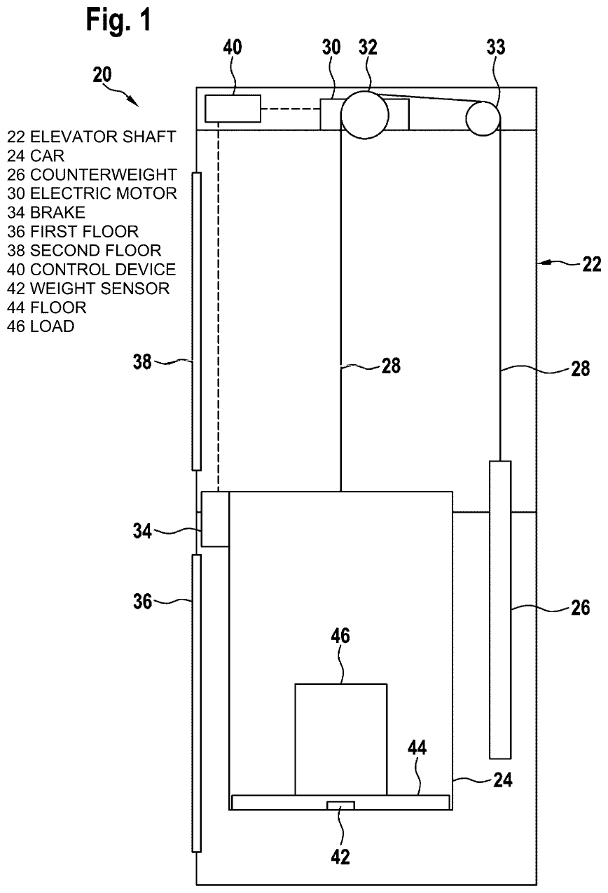

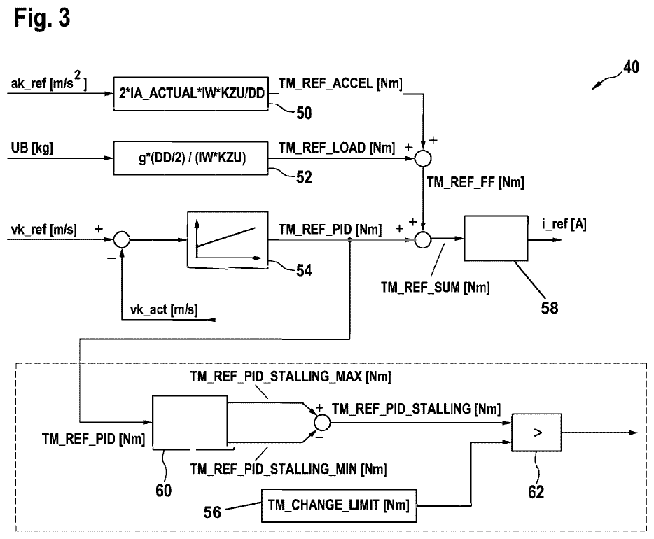

FIG. 1 shows an elevator system 20, as described above at the outset. The elevator system 20 has an elevator shaft 22, a car 24, a counterweight 26, an electric motor 30 which has a traction sheave 32, carrying means 28, optionally a deflection roller 33, a brake 34, and a control device 40 for controlling the electric motor 30. A load 46, which is intended to be transported by means of the car 24, is located in the car 24. A weight sensor 42 for detecting a weight (or weight difference, also UB) (see FIG. 3) of the load 46 is arranged in a floor 44 of the car 24.

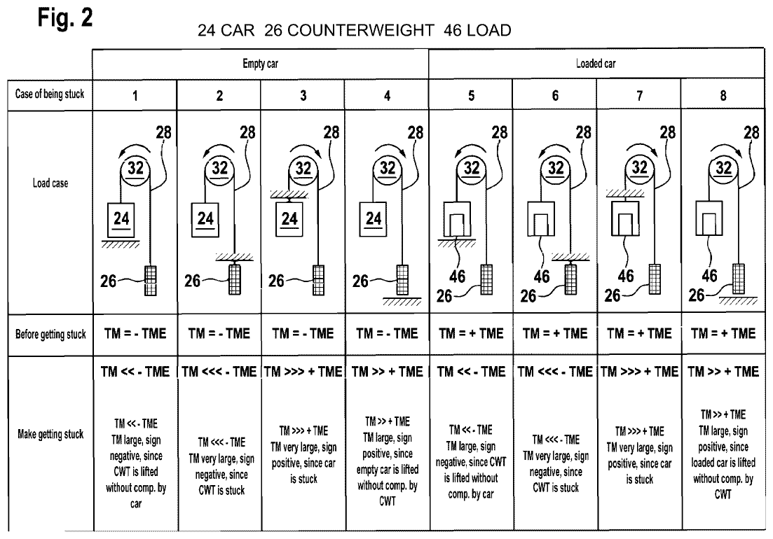

FIG. 2 shows the table explained above, in which the different possible cases of being stuck are illustrated. It is clear from FIG. 2, inter alia, that in all cases of being stuck and thus also in all situations of being stuck, which comprise the cases of being stuck, an amount of torque that the electric motor has to apply in order to reach the desired acceleration and/or speed increases greatly.

FIG. 3 shows a control device 40 according to one embodiment of the invention. The control device 40 serves to control the electric motor 30, depending on a weight of the load 46, a specified reference acceleration ak_ref and a specified reference speed vk_ref, in such a way that the car 24 moves with the specified reference acceleration ak_ref and at the specified reference speed vk_ref. In addition, the control device 40 serves to quickly and reliably identify a situation of being stuck, in which either the car 24 or the counterweight 26 remains stuck in the elevator shaft 22. FIG. 3 only shows the components of the control device 40 that are relevant for executing the method for identifying the situation of being stuck. In fact, the control device 40 can have further components, which, however, are not shown in the drawings in order not to unnecessarily obscure the subject matter of the present invention.

The control device 40 has on an acceleration torque determiner 50, a load torque determiner 52, a speed torque determiner 54, a torque limiter 56, a reference current determiner 58, a floating window determiner 60, and a 62 comparator.

The acceleration torque determiner 50 determines an acceleration torque TM_REF_ACCEL depending on the specified reference acceleration ak_ref and a current mass moment of inertia IA_ACTUAL, which is representative of the current mass inertia of the elevator system 20. The current mass moment of inertia IA_ACTUAL is dependent, among other things, on the load 46, which can be determined by means of the weight sensor 42 in the floor 44 of the driver's car 24. The acceleration torque determiner 50 determines the acceleration torque TM_REF_ACCEL in particular such that the car 24 moves with the reference acceleration ak_ref due to the acceleration torque TM_REF_ACCEL. The acceleration torque TM_REF_ACCEL can be determined, for example, by means of the following formula:

$$TM\_REF \_ACCEL = \frac{2 \cdot KZU \cdot IW}{DD} \cdot IA\_ACTUAL \cdot ak\_ref$$

with a traction sheave diameter DD, a reeving factor KZU, and a gear ratio IW. The current mass moment of inertia IA_ACTUAL can be defined as follows:

$$IA\_ACTUAL = IA\_Para - \frac{[ GQ \cdot ( 1 - \frac{KG}{100} ) - unbalance ] \cdot {( \frac{DD}{2} )}^{2}}{{( KZU \cdot IW )}^{2}}$$

IA_Para is an inverter parameter, which is representative of the total mass inertia of the elevator system at full payload. KG is a balancing factor, which indicates the percentage of the car mass for which the counterweight mass is designed. GQ is the permissible total weight.

The load torque determiner 52 determines, on the basis of a first load signal, a load torque TM_REF_LOAD in such a way that when the brake 34 is released, the car 24 does not move due to the determined load torque TM_REF_LOAD alone. The load torque TM_REF_LOAD can be determined, for example, by means of the following formula:

$$TM\_REF \_LOAD = \frac{g \cdot DD}{2 \cdot KZU \cdot IW} \cdot UB$$

With the gravitational constant g. The load signal is representative of a difference UB between a weight suspended on a side of the traction sheave 32 on which the counterweight 26 is suspended, and a weight suspended on a side of the traction sheave 32 on which the car 24 is suspended. It should be noted here that the weight suspended on the side of the traction sheave 32 on which the counterweight 26 is suspended also includes the weight of the carrying means 28 that extend from the counterweight 26 to the return roller 33 at the corresponding point in time, and that the weight suspended on a side of the traction sheave 32 on which the car 24 is suspended also includes the weight of the carrying means 28 that extend from the car 24 to the traction sheave 32 at the corresponding point in time. Since the weight of the car 24 and the counterweight 26 and the specific weight of the carrying means 28 as well as a current position of the car 24 are known, the weight of the load 46 can be determined using the difference UB. In other words, the difference UB is representative of the load 46.

The acceleration torque TM_REF_ACCEL and the load torque TM_REF_LOAD are added to give a preliminary torque TM_REF_FF.

The speed torque determiner 54 determines a correction torque TM_REF_PID depending on the reference speed vk_ref and an actual speed vk_act of the car 24. In particular, the speed torque determiner 54 determines the correction torque TM_REF_PID depending on a difference between the reference speed vk_ref and the actual speed vk_act of the car 24. For example, the speed torque determiner 54 can have an assignment rule, an assignment table, and/or an assignment function, by means of which a correction torque TM_REF_PID is uniquely assigned to a specified difference between the reference speed vk_ref and the actual speed vk_act. The correction torque TM_REF_PID is determined such that the car moves at the reference speed vk_ref or at least approximates the reference speed vk_ref.

The correction torque TM_REF_PID is added to the preliminary torque TM_REF_FF, giving a total torque TM_REF_SUM. Reference currents I_ref for controlling the electric motor are generated from the TM_REF_SUM by the reference current determiner 58.

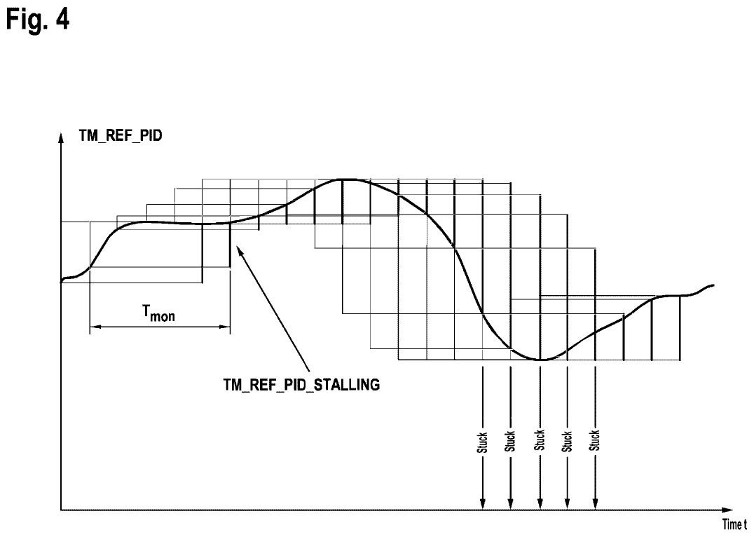

The floating window determiner 60 determines a maximum correction torque TM_REF_PID_STALLING_MAX and a minimum correction torque TM_REF_PID_STALLING_MIN within a specified time period, which, for example, can be represented by a floating window Tₘₒₙ (see FIG. 4), on the basis of the correction torque TM_REF_PID. By subtracting the minimum correction torque TM_REF_PID_STALLING_MIN from the maximum correction torque TM_REF_PID_STALLING_MAX, a torque difference TM_REF_PID_STALLING between the maximum correction torque TM_REF_PID_STALLING_MAX and the minimum correction torque TM_REF_PID_STALLING_MIN can be determined.

The comparator 62 compares the torque difference TM_REF_PID_STALLING with a specified threshold TM_CHANGE_LIMIT and outputs a signal representative of the occurrence of a situation of being stuck when the torque difference TM_REF_PID_STALLING is greater than a specified threshold TM_CHANGE_LIMIT, and outputs a signal representative of normal operation when the torque difference TM_REF_PID_STALLING is less than the threshold TM_CHANGE_LIMIT. The specified threshold TM_CHANGE_LIMIT is provided by the torque limiter 56.

FIG. 4 shows an exemplary profile of the torque difference TM_REF_PID_STALLING between the maximum correction torque TM_REF_PID_STALLING_MAX and the minimum correction torque TM_REF_PID_STALLING_MIN. Furthermore, FIG. 4 shows the floating window Tₘₒₙ that is representative of the time period within which the torque difference TM_REF_PID_STALLING is determined depending on the maximum correction torque TM_REF_PID_STALLING_MAX and the minimum correction torque the torque difference TM_REF_PID_STALLING_MIN. As soon as TM_REF_PID_STALLING is greater than the threshold TM_CHANGE_LIMIT, the car 24 or the counterweight 26 is identified as being stuck and thus the presence of the situation of being stuck is identified.

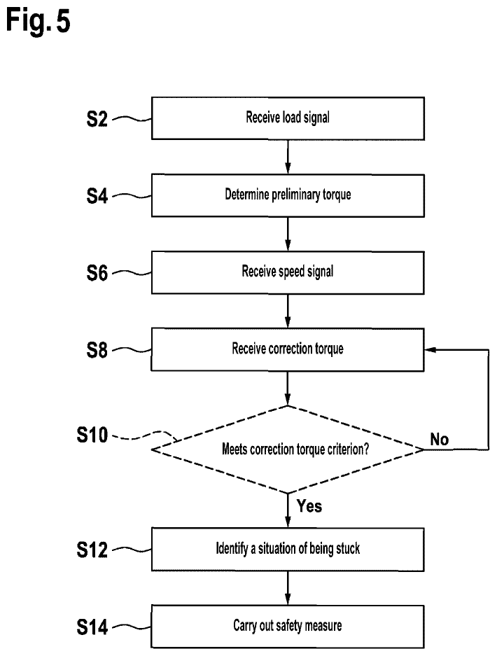

FIG. 5 shows a flow chart for a method according to one embodiment of the invention. The method serves to reliably and quickly identify the above-described situations of being stuck. The method can, for example, be processed by the control device 40.

In a step S2, the load signal is received that is representative of the weight of the load 46 which is located in the car 24 and which is intended to be transported by means of the car 24.

In a step S4, the preliminary torque TM_REF_FF is determined depending on the load signal, for example as explained with reference to FIG. 3.

In a step S6, the speed signal that is representative of the actual speed vk_act of the car 24 is received.

In a step S8, the correction torque TM_REF_PID is monitored over a specified monitoring time period, wherein the correction torque TM_REF_PID is determined depending on the speed signal and the specified reference speed vk_ref such that the actual speed vk_act of the car 24 approximates the reference speed vk_ref, for example by means of the control loop shown in FIG. 3.

In a step S10, a check is made to see whether the monitored correction torque TM_REF_PID meets at least one specified criterion. The specified criterion can be met, for example, if the torque difference TM_REF_PID_STALLING is greater than the specified threshold TM_CHANGE_LIMIT. If the condition in step S10 is met, processing can be continued in a step S12. If the condition in step S10 is not met, processing can be continued in step S8.

In step S12, the presence of the situation of being stuck, in which the car 24 or the counterweight 26 remains stuck in the elevator shaft 22, is identified.

A specified safety measure can be carried out in a step S14. For example, the car 24 and/or the counterweight 26 can be stopped by means of corresponding brakes, for example by means of the brake 34. Alternatively or additionally, the electric motor 30 can be switched off.

The method can be started when the elevator system 20 is started up. Alternatively, the method can be started when the car 24 begins to travel. Alternatively, the start of the method can be coupled to a starting condition and only started when the starting condition is met. This can contribute to avoiding a jolting phase, in which a jolt is transmitted to the car 24 and which can occur when the car 24 begins moving, being incorrectly identified as a situation of being stuck. The starting condition can be met, for example, if the reference speed vk_ref is not equal to zero. Alternatively or additionally, the starting condition can be met if a specified time period, for example from a few milliseconds to a few seconds, has elapsed after the journey with the car 24 has commenced. Alternatively or additionally, the correction torque TM_REF_PID can already be determined before starting the method, and the method can be started only once the torque difference TM_REF_PID_STALLING between the maximum correction torque TM_REF_PID_STALLING_MAX and the minimum correction torque TM_REF_PID_STALLING_MIN is greater than the threshold TM_CHANGE_LIMIT within the specified time window.

Finally, it should be noted that terms such as “comprising,” “having,” etc. do not exclude other elements or steps, and terms such as “a” or “an” do not exclude a plurality. Furthermore, it should be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A method for identifying a situation of being stuck in an elevator system, wherein the elevator system has an elevator shaft, a car arranged in the elevator shaft, a counterweight arranged in the elevator shaft and being connected to the car by a carrying means, an electric motor having a traction sheave over which traction sheave the carrying means runs, wherein the electric motor rotates the traction sheave to move the carrying means so that the car and the counterweight are displaced vertically, and a brake by which the car and/or the counterweight is braked and/or stopped, the method comprising:
receiving a load signal representative of a weight of a load located in the car, the load intended to be transported by the car;
determining a preliminary torque depending on the load signal;
receiving a speed signal representative of an actual speed of the car;
monitoring a correction torque over a specified monitoring time period, wherein the correction torque is determined depending on the speed signal and a specified reference speed, and using the preliminary torque and the correction torque to control the electric motor such that the actual speed of the car approximates the reference speed;
identifying the situation of being stuck, in which the car or the counterweight remains stuck in the elevator shaft when the monitored correction torque meets at least one specified criterion; and
performing a specified safety measure when the situation of being stuck is identified.

17. The method according to claim 16 wherein, when monitoring the correction torque, determining a maximum correction torque and a minimum correction torque within the specified time period, and wherein the at least one specified criterion is met if a difference between the maximum correction torque and the minimum correction torque is greater than a specified threshold.

18. The method according to claim 16 including determining a total torque depending on the preliminary torque and the correction torque, and determining at least one reference current for operating the electric motor depending on the total torque.

19. The method according to claim 16 wherein the preliminary torque comprises a load torque added to an acceleration torque.

20. The method according to claim 19 including determining the load torque such that, when the brake is released, the car does not move as a result of the determined load torque alone.

21. The method according to claim 19 wherein the load signal is representative of a difference between a first weight suspended on a side of the traction sheave on which the counterweight is suspended and a second weight suspended on a side of the traction sheave on which the car is suspended, and the load torque is determined depending on the load signal.

22. The method according to claim 19 including determining the acceleration torque such that the car moves with a reference acceleration due to the acceleration torque.

23. The method according to claim 19 including determining a current mass moment of inertia representative of a current mass inertia of the elevator system, and determining the acceleration torque depending on the current mass moment of inertia and a reference acceleration.

24. The method according to claim 16 wherein the specified safety measure comprises stopping the electric motor and/or generating an error message.

25. The method according to claim 16 including starting monitoring of the correction torque when at least one specified starting condition is met.

26. The method according to claim 25 wherein the at least one specified starting condition comprises:
the correction torque is determined twice in a row, and the correction torque meets the at least one specified criterion in both determinations;
the reference speed is not equal to zero; and/or
after the car has started moving, a specified run-up period has elapsed.

27. A control device for an elevator system, the control device including a processor adapted to perform the method according to claim 16 and a weight sensor generating the load signal.

28. An elevator system comprising:
the control device according to claim 27;
an elevator shaft;
a car arranged in the elevator shaft;
a counterweight arranged in the elevator shaft and connected to the car by a carrying means;
an electric motor having a traction sheave over which traction sheave the carrying means runs, wherein the electric motor rotates the traction sheave to move the carrying means so that the car and the counterweight are displaced vertically; and
a brake by which the car and/or the counterweight is braked and/or stopped.

29. A computer program stored on a non-transitory computer-readable medium and comprising commands that when executed by a processor cause the method steps according to claim 16 to be carried out.

30. A non-transitory computer-readable medium on which the computer program according to claim 29 is stored.
